(19) United States
(12) Patent Application Publication
(10) Pub. No.: US 2026/0149077 A1
(43) Pub. Date: May 28, 2026

(54) SECONDARY BATTERY

(71) Applicant: TOYOTA JIDOSHA KABUSHIKI KAISHA, Toyota-shi (JP)

(72) Inventor: Shintaro NAGANO, Nisshin-shi (JP)

(73) Assignee: TOYOTA JIDOSHA KABUSHIKI KAISHA, Toyota-shi (JP)

(21) Appl. No.: 19/323,218

(22) Filed: Sep. 9, 2025

(30) Foreign Application Priority Data
Nov. 25, 2024 (JP) 2024-205003

(51) Int. Cl. H01M 10/615; H01M 10/6551; H01M 10/6572; H01M 10/659

(52) U.S. Cl. CPC H01M 10/615; H01M 10/6551; H01M 10/6572; H01M 10/659

(57) ABSTRACT

A secondary battery includes an electrode stored in a casing. The casing is a vacuum container including a container-shaped inner wall portion and a container-shaped outer wall portion configured to house the inner wall portion, with a vacuum space defined between the inner wall portion and the outer wall portion. The electrode is stored in a storage space defined inside the inner wall portion. A heat dissipation element is provided on a surface of the inner wall portion facing the vacuum space.

### CROSS-REFERENCE TO RELATED APPLICATION

This application claims priority to Japanese Patent Application No. 2024-205003 filed on Nov. 25, 2024. The disclosure of the above-identified application, including the specification, drawings, and claims, is incorporated by reference herein in its entirety.

### BACKGROUND

### 1. Technical Field

The present disclosure relates to a secondary battery.

### 2. Description of Related Art

Japanese Unexamined Patent Application Publication No. 2017-222239 (JP 2017-222239 A) discloses a secondary battery heating device that heats a secondary battery through a latent heat storage material covering the secondary battery.

### SUMMARY

When the secondary battery is heated from the outside of a casing of the secondary battery, excessive temperature rise or heat transfer loss is likely to occur. Therefore, it is difficult to efficiently heat the secondary battery.

The present disclosure has been made in view of the above problem, and an object of the present disclosure is to provide a secondary battery that can efficiently be heated while suppressing excessive temperature rise.

To solve the above problem and achieve the above object, a secondary battery according to the present disclosure is a secondary battery including an electrode stored in a casing. The casing is a vacuum container including a container-shaped inner wall portion and a container-shaped outer wall portion configured to house the inner wall portion, with a vacuum space defined between the inner wall portion and the outer wall portion. The electrode is stored in a storage space defined inside the inner wall portion. A heat dissipation element is provided on a surface of the inner wall portion facing the vacuum space.

Thus, the secondary battery according to the present disclosure can efficiently be heated while suppressing the excessive temperature rise.

In the above, the electrode may be in contact with only the inner wall portion of the casing.

Thus, the heat insulating effect can be improved.

In the above, the electrode may be not in contact with the casing.

Thus, the heat insulating effect can be improved.

A secondary battery according to the present disclosure is a secondary battery including a plurality of battery cells stored in a casing. The casing is a vacuum container including a container-shaped inner wall portion and a container-shaped outer wall portion configured to house the inner wall portion, with a vacuum space defined between the inner wall portion and the outer wall portion. The battery cells are stored in a storage space defined inside the inner wall portion. A heat dissipation element is provided on a surface of the inner wall portion facing the vacuum space.

Thus, the secondary battery according to the present disclosure can efficiently be heated while suppressing the excessive temperature rise.

The secondary battery according to the present disclosure can efficiently maintain a high temperature by storing heat generated by charging and discharging due to the heat insulating structure of the casing. Moreover, the heat dissipation element has an effect of suppressing excessive heat storage.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a sectional view showing a schematic configuration of a battery cell according to a first embodiment;

FIG. 2 is a sectional view showing a schematic configuration of a battery cell according to a second embodiment;

FIG. 3 is a sectional view showing a schematic configuration of a battery cell according to a third embodiment; and

FIG. 4 is a sectional view showing a schematic configuration of a battery pack according to a fourth embodiment.

### DETAILED DESCRIPTION OF EMBODIMENTS

### First Embodiment

A secondary battery according to a first embodiment of the present disclosure will be described below. The present disclosure is not limited to the present embodiment.

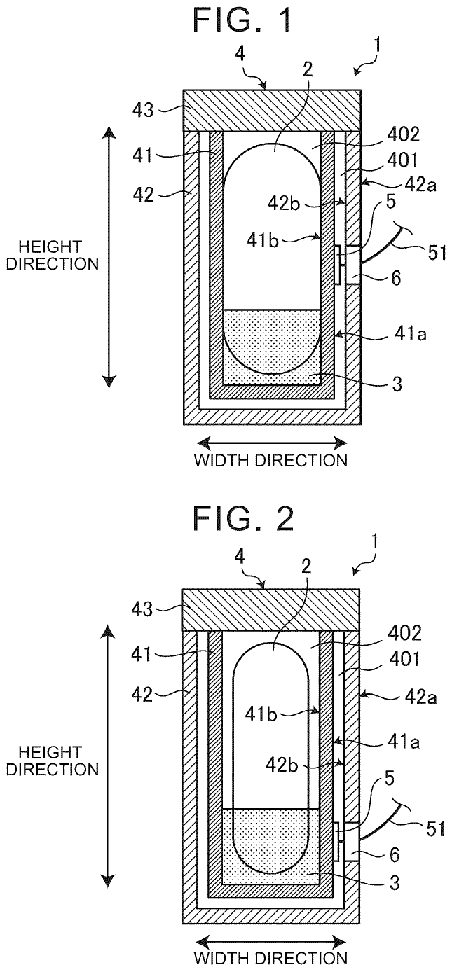

FIG. 1 is a sectional view showing a schematic configuration of a battery cell 1 according to the first embodiment. The “height direction” in FIG. 1 is the height direction of the battery cell 1, and the “width direction” in FIG. 1 is the width direction of the battery cell 1.

As shown in FIG. 1, the battery cell 1 according to the first embodiment includes an electrode 2, an electrolyte 3, a battery cell casing 4, a heat dissipation element 5, and an airtight connector 6. The battery cell 1 according to the first embodiment is a secondary battery that stores the electrode 2 and the electrolyte 3 in the battery cell casing 4.

The battery cell casing 4 is made of, for example, a metal material, and includes an inner wall portion 41, an outer wall portion 42, and a lid portion 43. The inner wall portion 41 has a box container shape that is open on one side, namely at the top. The outer wall portion 42 has a box shape that is open on one side, namely at the top, and has a container shape larger than that of the inner wall portion 41 such that the inner wall portion 41 can be housed in the inner space with a clearance from the inner wall portion 41. The lid portion 43 has a plate shape that closes the openings of the inner wall portion 41 and the outer wall portion 42. The lid portion 43 is connected to the upper ends of the inner wall portion 41 and the outer wall portion 42. The battery cell casing 4 is a vacuum container enclosed by the inner wall portion 41, the outer wall portion 42, and the lid portion 43 with a vacuum space 401 defined in the width direction between an outer surface 41a of the inner wall portion 41 and an inner surface 42b of the outer wall portion 42.

In the battery cell casing 4, a storage space (space inside the inner wall portion 41) 402 enclosed by the inner wall portion 41 and the lid portion 43 stores the electrode 2 and is filled with the electrolyte 3 such that at least part of the electrode 2 is immersed. In the battery cell 1 according to the first embodiment, the electrode 2 stored in the storage space 402 is disposed in contact with only an inner surface 41b of the inner wall portion 41 in the width direction out of the inner wall portion 41 and the lid portion 43 that define the storage space 402. Therefore, the outer surface 41a of the inner wall portion 41 is in contact with the vacuum space 401 of the battery cell casing 4 but is not in contact with the external environment around the battery cell casing 4 (space outside the battery cell casing 4). Thus, the heat insulating effect can be improved compared to the case where the electrode 2 is in contact with the lid portion 43 that is in contact with the external environment.

The heat dissipation element 5 is provided on the outer surface 41a that is the surface of the inner wall portion 41 facing the vacuum space 401. In the battery cell 1 according to the first embodiment, a Peltier element is used as the heat dissipation element 5. The heat dissipation element 5 is not limited to the Peltier element. It is preferable to use an element having a great heat absorbing effect as in the case of the Peltier element.

In the battery cell 1 according to the first embodiment, the heat dissipation element 5 is provided in contact with a position on the outer surface 41a of the inner wall portion 41 that corresponds to the portion of the inner surface 41b of the inner wall portion 41 that is in contact with the electrode 2. A wire 51 for causing a current to flow from a power supply (not shown) to the heat dissipation element 5 is connected to the heat dissipation element 5. The wire 51 is taken out from the vacuum space 401 in which the heat dissipation element 5 is provided to the outside of the battery cell casing 4 (outward of an outer surface 42a of the outer wall portion 42) via the airtight connector 6 provided on the outer wall portion 42. In order not to impair the heat insulating effect, the heat dissipation element 5 is installed out of contact with the outer wall portion 42 and the airtight connector 6 that are in contact with the external environment.

In the battery cell 1 according to the first embodiment, the heat dissipation element 5 can dissipate heat generated by charging and discharging and transferred from the electrode 2 to the inner wall portion 41 by causing a current to flow from the power supply to the heat dissipation element 5 through the wire 51 at any appropriate timing. Examples of the any appropriate timing include a timing when a predetermined charging period has elapsed, a timing when a predetermined discharging period has elapsed, and a timing when the temperature of the battery cell 1 measured by a temperature sensor (not shown) has reached a predetermined temperature or higher. By providing the heat dissipation element 5 in contact with the above position, it is possible to maximize the heat dissipation effect of the heat dissipation element 5.

In the battery cell 1 according to the first embodiment, the vacuum space 401 is provided between the external environment and the storage space 402 of the battery cell casing 4 in which the electrode 2 is stored, thereby thermally insulating the storage space 402 from the external environment. Therefore, in the battery cell 1 according to the first embodiment, the heat generated in the electrode 2 by charging and discharging is less likely to be dissipated from the storage space 402 to the external environment due to the vacuum space 401. Thus, the heat can be stored in the storage space 402. In the battery cell 1 according to the first embodiment, the heat dissipation element 5 is provided on the outer surface 41a of the inner wall portion 41 and dissipates heat at any appropriate timing. Therefore, it is possible to reduce the risk of excessive temperature rise in the storage space 402 that may be caused when the heat dissipation from the storage space 402 is less likely to occur. Thus, the battery cell 1 according to the first embodiment can efficiently be heated while suppressing the excessive temperature rise.

Particularly in quick charging, the charging performance decreases when the temperature of the electrode 2 is low. By providing the vacuum space 401 in the battery cell casing 4 for heat insulation as in the battery cell 1 according to the first embodiment, the electrode 2 is less likely to be cooled. Therefore, the situation in which the temperature of the electrode 2 is low can be reduced and the charging performance can be improved. In the battery cell 1 according to the first embodiment, the heat dissipation function is provided by the heat dissipation element 5. Therefore, excessive heat storage can be suppressed and abnormal deterioration of the battery cell 1 can be suppressed.

### Second Embodiment

A secondary battery according to a second embodiment of the present disclosure will be described below. In the second embodiment, the same description as in the first embodiment will be omitted as appropriate.

FIG. 2 is a sectional view showing a schematic configuration of a battery cell 1 according to the second embodiment.

As shown in FIG. 2, in the battery cell 1 according to the second embodiment, the electrode 2 stored in the storage space 402 of the battery cell casing 4 is disposed out of contact with the battery cell casing 4. Specifically, the electrode 2 stored in the storage space 402 is disposed out of contact with both the inner wall portion 41 and the lid portion 43 that define the storage space 402 in the battery cell casing 4. In the battery cell 1 according to the second embodiment, the electrode 2 may be supported within the storage space 402, for example, by a support member (not shown) having heat insulating properties.

Since the electrode 2 stored in the storage space 402 is disposed out of contact with the battery cell casing 4 in the battery cell 1 according to the second embodiment, the heat insulating effect can be improved compared to the case where the electrode 2 is in contact with the battery cell casing 4. Therefore, in the battery cell 1 according to the second embodiment, the situation in which the temperature of the electrode 2 is low can further be reduced and the charging performance can further be improved.

Since the electrode 2 stored in the storage space 402 is not in contact with the battery cell casing 4 (inner surface 41b of the inner wall portion 41) in the battery cell 1 according to the second embodiment, heat dissipation from the electrolyte 3 in the storage space 402 by the heat dissipation element 5 is effective in reducing the risk of excessive temperature rise. Therefore, in the battery cell 1 according to the second embodiment, the heat dissipation element 5 is provided in contact with a position on the outer surface 41a of the inner wall portion 41 that corresponds to the portion of the inner surface 41b of the inner wall portion 41 that is in contact with the electrolyte 3. In the battery cell 1 according to the second embodiment, the heat dissipation element 5 can dissipate, via the inner wall portion 41, heat generated by charging and discharging and transferred from the electrode 2 to the electrolyte 3 by causing a current to flow from the wire 51 to the heat dissipation element 5 at any appropriate timing. Therefore, in the battery cell 1 according to the second embodiment, it is possible to reduce the risk of excessive temperature rise in the storage space 402 that may be caused when the heat dissipation from the storage space 402 to the external environment is less likely to occur. Thus, the battery cell 1 according to the second embodiment can efficiently be heated while suppressing the excessive temperature rise.

### Third Embodiment

A secondary battery according to a third embodiment of the present disclosure will be described below. In the third embodiment, the same description as in the first embodiment will be omitted as appropriate. In the battery cell 1 according to the third embodiment, a plurality of electrodes 2 is stored in the storage space 402 of the battery cell casing 4 unlike the battery cell 1 according to the first embodiment in which one electrode 2 is stored in the storage space 402 of the battery cell casing 4.

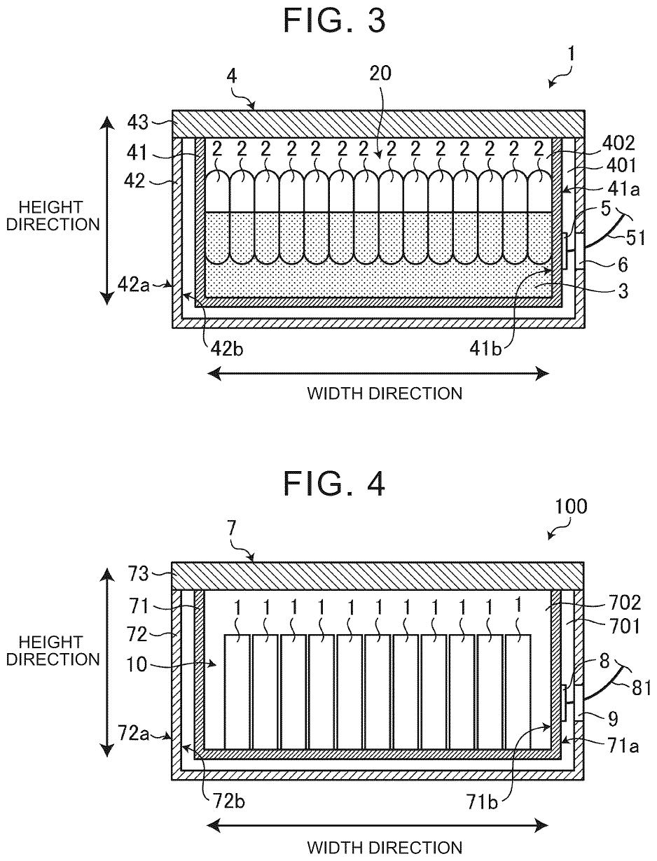

FIG. 3 is a sectional view showing a schematic configuration of the battery cell 1 according to the third embodiment.

As shown in FIG. 3, in the battery cell 1 according to the third embodiment, the electrodes 2 are stored in the storage space 402 of the battery cell casing 4 as an electrode group 20 in which the electrodes 2 are arranged side by side and in contact with each other in the width direction of the battery cell 1. In the battery cell 1 according to the third embodiment, none of the electrodes 2 constituting the electrode group 20 are in contact with the lid portion 43 that defines the storage space 402. Among the electrodes 2 constituting the electrode group 20, two electrodes 2 located at both ends in the width direction are in contact, in the width direction, with the inner surface 41b of the inner wall portion 41 that defines the storage space 402. Therefore, in the battery cell 1 according to the third embodiment, the heat generated by charging and discharging in the electrodes 2 constituting the electrode group 20 is less likely to be dissipated from the storage space 402 to the external environment due to the vacuum space 401. Thus, the heat can be stored in the storage space 402.

In the battery cell 1 according to the third embodiment, as shown in FIG. 3, the heat dissipation element 5 is provided in contact with a position on the outer surface 41a of the inner wall portion 41 that corresponds to the portion of the inner surface 41b of the inner wall portion 41 that is in contact with the electrode 2 and the electrolyte 3. In the battery cell 1 according to the third embodiment, the heat dissipation element 5 can dissipate heat generated by charging and discharging and transferred from the electrodes 2 and the electrolyte 3 to the inner wall portion 41 by causing a current to flow from the wire 51 to the heat dissipation element 5 at any appropriate timing. Therefore, in the battery cell 1 according to the third embodiment, it is possible to reduce the risk of excessive temperature rise in the storage space 402 that may be caused when the heat dissipation from the storage space 402 to the external environment is less likely to occur. The heat dissipation element 5 is preferably provided at a position on the outer surface 41a of the inner wall portion 41 that corresponds to at least the portion of the inner surface 41b of the inner wall portion 41 that is in contact with the electrode 2.

As described above, the battery cell 1 according to the third embodiment can efficiently be heated while suppressing the excessive temperature rise.

In the battery cell 1 according to the third embodiment, all of the electrodes 2 constituting the electrode group 20 may be kept out of contact with the battery cell casing 4 as in the battery cell 1 according to the second embodiment. In this case, the heat dissipation element 5 is preferably provided on the outer surface 41a of the inner wall portion 41 that corresponds to the portion of the inner surface 41b of the inner wall portion 41 that is in contact with the electrolyte 3.

### Fourth Embodiment

A secondary battery according to a fourth embodiment of the present disclosure will be described below. The present disclosure is not limited to the present embodiment.

FIG. 4 is a sectional view showing a schematic configuration of a battery pack 100 according to the fourth embodiment. The “height direction” in FIG. 4 is the height direction of the battery pack 100, and the “width direction” in FIG. 4 is the width direction of the battery pack 100.

As shown in FIG. 4, the battery pack 100 according to the fourth embodiment includes a battery assembly 10, a battery pack casing 7, a heat dissipation element 8, and an airtight connector 9. The battery pack 100 according to the fourth embodiment is a secondary battery that stores the battery assembly 10 in the battery pack casing 7. In the battery assembly 10, a plurality of battery cells 1 is arranged side by side in the width direction of the battery pack 100.

The battery cell 1 is not limited to the battery cell 1 according to any one of the first to third embodiments, in other words, the battery cell 1 provided with the vacuum space 401 within the battery cell casing 4. In the present embodiment, the height direction of the battery pack 100 is the same as the height direction of the battery cell 1, and the width direction of the battery pack 100 is the same as the width direction of the battery cell 1.

The battery pack casing 7 is made of, for example, a metal material, and includes an inner wall portion 71, an outer wall portion 72, and a lid portion 73. The inner wall portion 71 has a box container shape that is open on one side, namely at the top. The outer wall portion 72 has a box shape that is open on one side, namely at the top, and has a container shape larger than that of the inner wall portion 71 such that the inner wall portion 71 can be housed in the inner space with a clearance from the inner wall portion 71. The lid portion 73 has a plate shape that closes the openings of the inner wall portion 71 and the outer wall portion 72. The lid portion 73 is connected to the upper ends of the inner wall portion 71 and the outer wall portion 72. The battery pack casing 7 is a vacuum container enclosed by the inner wall portion 71, the outer wall portion 72, and the lid portion 73 with a vacuum space 701 defined in the width direction between an outer surface 71a of the inner wall portion 71 and an inner surface 72b of the outer wall portion 72.

In the battery pack casing 7, the battery assembly 10 is stored in a storage space (space inside the inner wall portion 71) 702 enclosed by the inner wall portion 71 and the lid portion 73. In the battery pack 100 according to the fourth embodiment, the battery assembly 10 (each battery cell 1) stored in the storage space 702 is disposed in contact with only an inner surface 71b of the inner wall portion 71 at the bottom in the height direction out of the inner wall portion 71 and the lid portion 73 that define the storage space 702. Therefore, the outer surface 71a of the inner wall portion 71 is in contact with the vacuum space 701 of the battery pack casing 7 but is not in contact with the external environment around the battery pack casing 7 (space outside the battery pack casing 7). Thus, the heat insulating effect can be improved compared to the case where the battery assembly 10 (each battery cell 1) is in contact with the lid portion 73 of the battery pack casing 7 that is in contact with the external environment.

The heat dissipation element 8 is provided on the outer surface 71a that is the surface of the inner wall portion 71 facing the vacuum space 701. In the battery pack 100 according to the fourth embodiment, a Peltier element is used as the heat dissipation element 8. The heat dissipation element 8 is not limited to the Peltier element. It is preferable to use an element having a great heat absorbing effect as in the case of the Peltier element.

In the battery pack 100 according to the fourth embodiment, the heat dissipation element 8 is provided in contact with the outer surface 71a in the width direction on the inner wall portion 71 that is in contact with the bottom surface of the battery assembly 10 (each battery cell 1). A wire 81 for causing a current to flow from a power supply (not shown) to the heat dissipation element 8 is connected to the heat dissipation element 8. The wire 81 is taken out from the vacuum space 701 in which the heat dissipation element 8 is provided to the outside of the battery pack casing 7 (outward of an outer surface 72a of the outer wall portion 72) via the airtight connector 9 provided on the outer wall portion 72. In order not to impair the heat insulating effect, the heat dissipation element 8 is installed out of contact with the outer wall portion 72 and the airtight connector 9 that are in contact with the external environment around the battery pack 100.

In the battery pack 100 according to the fourth embodiment, the heat dissipation element 8 can dissipate heat generated by charging and discharging and transferred from the battery assembly 10 (each battery cell 1) to the inner wall portion 71 by causing a current to flow from the power supply to the heat dissipation element 8 through the wire 81 at any appropriate timing. Examples of the any appropriate timing include a timing when a predetermined charging period has elapsed, a timing when a predetermined discharging period has elapsed, and a timing when the temperature of the battery assembly 10 (each battery cell 1) measured by a temperature sensor (not shown) has reached a predetermined temperature or higher.

In the battery pack 100 according to the fourth embodiment, the vacuum space 701 is provided between the external environment and the storage space 702 of the battery pack casing 7 in which the battery assembly 10 is stored, thereby thermally insulating the storage space 702 from the external environment. Therefore, in the battery pack 100 according to the fourth embodiment, the heat generated in the battery assembly 10 (each battery cell 1) by charging and discharging is less likely to be dissipated from the storage space 702 to the external environment due to the vacuum space 701. Thus, the heat can be stored in the storage space 702. In the battery pack 100 according to the fourth embodiment, the heat dissipation element 8 is provided on the outer surface 71a of the inner wall portion 71 and dissipates heat at any appropriate timing. Therefore, it is possible to reduce the risk of excessive temperature rise in the storage space 702 that may be caused when the heat dissipation from the storage space 702 is less likely to occur.

Thus, the battery pack 100 according to the fourth embodiment can efficiently be heated while suppressing the excessive temperature rise.

By providing the vacuum space 701 in the battery pack casing 7 for heat insulation as in the battery pack 100 according to the fourth embodiment, the battery assembly 10 (each battery cell 1) is less likely to be cooled. Therefore, in the battery pack 100 according to the fourth embodiment, the situation in which the temperature of the battery assembly 10 (each battery cell 1) is low can be reduced and the charging performance can be improved. In the battery pack 100 according to the fourth embodiment, the heat dissipation function is provided by the heat dissipation element 8. Therefore, excessive heat storage can be suppressed and abnormal deterioration of the battery assembly 10 (each battery cell 1) can be suppressed.

What is claimed is:

1. A secondary battery comprising an electrode stored in a casing, wherein:
the casing is a vacuum container including a container-shaped inner wall portion and a container-shaped outer wall portion configured to house the inner wall portion, with a vacuum space defined between the inner wall portion and the outer wall portion;
the electrode is stored in a storage space defined inside the inner wall portion; and
a heat dissipation element is provided on a surface of the inner wall portion facing the vacuum space.

2. The secondary battery according to claim 1, wherein the electrode is in contact with only the inner wall portion of the casing.

3. The secondary battery according to claim 1, wherein the electrode is not in contact with the casing.

4. A secondary battery comprising a plurality of battery cells stored in a casing, wherein:
the casing is a vacuum container including a container-shaped inner wall portion and a container-shaped outer wall portion configured to house the inner wall portion, with a vacuum space defined between the inner wall portion and the outer wall portion;
the battery cells are stored in a storage space defined inside the inner wall portion; and
a heat dissipation element is provided on a surface of the inner wall portion facing the vacuum space.
